(19) United States
(12) Patent Application Publication
(10) Pub. No.: US 2008/0159218 A1
(43) Pub. Date: Jul. 3, 2008

(54) METHOD OF EFFICIENT STATE TRANSITION IN ENHANCED CELL FACH

(75) Inventor: Pradeep Dwarakanath, Bangalore (IN)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/967,535

(22) Filed: Dec. 31, 2007

(30) Foreign Application Priority Data
Dec. 29, 2006 (IN) 2006-2469/CHE

(51) Int. Cl. H04Q 7/20

(52) U.S. Cl. 370/329

(57) ABSTRACT

A method of efficient state transition between CELL_DCH and CELL_FACH states is provided. According to the method, the transmission of configuration data through a physical data channel is reduced by using pre-configuration information or previously received/stored information for state transition. The indication regarding the use of pre-configuration information or previously received/stored information for state transition is conveyed through a high speed shared control channel (HS-SCCH), thus reducing the information sent through a high speed physical data shared channel (HS_PDSCH).

### PRIORITY

This application claims priority under 35 U.S.C. §119(a) to an application entitled “Method of Efficient State Transition in Enhanced Cell FACH” filed in India on Dec. 29, 2006 and assigned Serial No. 2469/CHE/2006, the contents of which are incorporated herein by reference.

### BACKGROUND OF THE INVENTION

1. Field of the Invention

The present invention in general relates to mobile wireless communication for 3^{rd} Generation Partnership Project (3GPP) Release 7 (R7) High Speed Packet Access (HSPA) mobile equipment, where a user equipment (UE) quickly switches between CELL_DCH and CELL_FACH states with very small overhead. Particularly, this invention relates to a method of efficient state transitioning in Enhanced CELL_FACH.

2. Description of the Related Art

As per 3GPP TS 25.212, the High Speed Shared Control Channel (HS-SCCH) carries Layer 1 (L1) control signaling to user equipments (UE). HS-SCCH is sent to the UEs to schedule them on a certain code and time resource. The contents of HS-SCCH are shown in FIG. 1 and described as follows: the channelization codes on which a UE will be scheduled and the modulation scheme that will be used on the data being sent to the UE are sent through the CCS and MS fields; the packet data unit size and format is sent through the TFRC field; the Hybrid Automatic Transmission Request (HARQ) process information is sent through the HARQ field; redundancy and constellation version (R & C Ver) for the support of HARQ is sent through the R & C Ver field; and an indication whether the UE is new data or a retransmission is indicated in HS-SCCH.

As per 3GPP TS 25.331, Radio Resource Control (RRC) control signaling is sent to lower layers in an acknowledged mode; segmentation is done at the Radio Link Control (RLC) level; RLC and Medium Access Control (MAC) will add corresponding headers and L1 will append a 24-bit Cyclic Redundancy Check (CRC) and then CRC will be transmitted through one or more code/time resources. Pre-configurations of such RRC messages are also possible as explained in the technical specification below. In all Enhanced Cell_FACH discussions in the 3GPP forum, a UE is supposed to read the HS-SCCH and then look for a corresponding message in the High Speed Physical Data Shared Channel (HS-PDSCH) for its specific messages. On the uplink, the UE will communicate to a Node B through a Random Access Channel (RACH). It is observed in a 3GPP RAN1 contribution R1-063043 entitled “State Transition Delay Reduction via Enhanced CELL_FACH”, that in the absence of initial link adaptation, for Node B HS-FACH power consumption to be maintained at a reasonable level, 3 to 4 “quick repeat” transmissions are needed to ensure 95% coverage of a message.

All messages that may cause a state transition are listed in Table 1. Here, the Node B communicates more than 360 bits of control data to effect a state transition from CELL_FACH to CELL_DCH. As per 3GPP RAN1 contribution R1-063043, 3 to 4 retransmissions are needed for ensuring users at the cell edges to receive the message with 1% Frame Error Rate (FER) in the absence of link adaptation and Acknowledge/Negative-Acknowledge (ACK/NACK) feedback. This will lead to 360*3=1080 bits of information, which will reduce the achievable throughput.

TABLE 1
Messages that may cause a state transition

| RRC Message causing CELL_FACH ←→CELL_DCH | RRC |
|---|---|
| with HS-DSCH/E-DCH | Message Size* |
| CELL Update confirm | 300-360 |
| Radio bearer reconfiguration | 552 |
| Transport channel reconfiguration | 552 |
| Physical channel reconfiguration | <552 |

*Note: Only RRC message size is mentioned in the table. Depending on the number of PDUs used in sending the RRC message, a total header of RLC header (2 bytes * no. of PDUs + 1) + MAC header (3 or 5 bytes of UE ID * no. of PDUs) + L1 (24 bit CRC * no. of PDUs) and ⅓ rate channel coding is added.

For example, considering CELL UPDATE CONFIRM message size of 300 bits and assuming 336 bits RLC PDU size, a total header of 384 bits (3 bytes of MAC header+24 bits CRC) is required for each transmission. Three quick repetitions will lead to 384*3=1152 bits. Considering 1/3 rate coding, 1152*3=3456 bits are required for transmitting a control message. The present invention provides a method to reduce the number of bits needed to effect such a state transition.

### SUMMARY OF THE INVENTION

In the prior art, RRC CELL UPDATE CONFIRM/RADIO BEARER RECONFIGURATION messages were transmitted using the HS-PDSCH with big overhead. It is an object of the present invention to reduce the message size used to communicate a state transition command to UEs by using pre-configuration data derived from one of the previously received and stored RRC messages and pre-configuration of RRC signaling messages. Such pre-configuration data is then communicated through HS-SCCH, using a pre-configuration index. Thus, HS-PDSCH need not be used for this purpose. Some of the redundant fields in HS-SCCH in the context of Enhanced CELL_FACH are reinterpreted. A method of communicating dedicated channelization codes such as Fractional Dedicated Physical Channel (F-DPCH) and Enhanced Relative Grant Channel (E-RGCH)/Enhanced HARQ Indicator Channel (E-HICH) is provided, where a set of 16 channelization codes are pre-sent to the UE and the network would communicate the index to be used in CELL_DCH. Under this invention, a large RRC signaling message is sent within the small field previously used for L1 control signaling in HS-SCCH.

The present invention needs no link adaptation and Modulation and Coding Scheme (MCS) selection to communicate the state transition command on HS-SCCH, because HS-SCCH is not power controlled to any particular UE.

The present invention provides an initial Measurement/Channel Quality Indicator (CQI) report on RACH is not required to aid the MCS selection for transmission of state transition command.

The present invention provides better cell edge detection and performance due to improved channel coding.

The present invention provides reduced latency in communication of state transmission command due to fewer bits transmitted and also fewer retransmissions.

The present invention provides that the HS-PDSCH is not used, leading to a higher utilization of code space and increased cell throughput. 12 bits in HS-SCCH are encoded with 1/3 rate coding as existing and are sufficient to communicate a state transition command within HS-SCCH itself.

The present invention provides efficient utilization of Node B power resources, as the Node B need not transmit a big message with multiple repetitions.

The present invention further provides an option for the network to solicit a Measurement/CQI report or to communicate a traffic volume measurement control message with very small overhead.

The present invention further provides that the control signaling on Iub interface between Radio Network Controller (RNC) and the Node B is reduced.

Instead of using pre-configurations, if a previously received and stored configuration is used for state transition, an RLC level acknowledgement can be supported with integrity protection to achieve virtually 0% error probability.

Accordingly, an aspect of the present invention is to provide a method for efficient state transition in Enhanced CELL_FACH, wherein the transition is made between CELL_DCH and CELL_FACH states, and the transmission of configuration data through a physical data channel is reduced by using pre-configuration information or previously received/stored information for state transition, where the indication regarding the use of the pre-configuration information or previously received/stored information for state transition is conveyed through a high speed shared control channel (HS-SCCH).

When using pre-configuration for state transition CELL UPDATE CONFIRM/RADIO BEARER RECONFIGURATION messages are sent to a UE at the beginning of connection establishment or the first time when the UE moves from CELL_FACH to CELL_DCH. The method further includes an associated network ordering the state to which the UE has to switch to and the index to the pre-defined configuration to be used in the new state. Prior F-DPCH and E-RGCH/E-HICH codes are stored by the UE and in case the codes are not reallocated, the codes are reused while entering CELL_DCH. If the codes are reassigned to other UEs, they have to be communicated to UEs for every transition to CELL_DCH.

A UE is sent 16 F-DPCH and 16 E-HICH/E-RGCH codes in advance at the time the UE first enters CELL_DCH. If there is a change in F-DPCH and E-RGCH codes, a UE is signaled the index to these pre-sent codes which the UE uses on transition to CELL_DCH. With UE specific Hybrid-Radio Network Temporary Identity (H-RNTI), when the UE detects a CRC corresponding to its H-RNTI, an unused combination of CCS fields indicate that there is no data carried on the HS-PDSCH and only a state transition command is being communicated to the UE on the HS-SCCH.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating the HS-SCCH frame format;

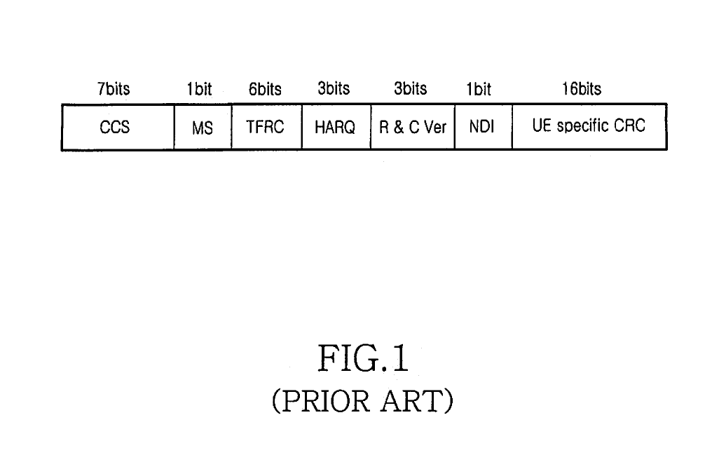

FIG. 2 is a diagram illustrating HS-SCCH fields with the use of pre-configuration of RRC messages according to an embodiment of the present invention;

FIG. 3 is a diagram illustrating the HS-SCCH fields when previously received RRC messages are used for state transition according to an embodiment of the present invention.

### DETAILED DESCRIPTION OF THE EXEMPLARY EMBODIMENT

The preferred embodiments of the present invention will now be explained with reference to the drawings. It should be understood however that the disclosed embodiments are merely exemplary of the invention, which may be embodied in various forms. The following description and drawings are not to be construed as limiting the invention and numerous specific details are described to provide a thorough understanding of the present invention as the basis for the claims and as a basis for teaching one skilled in the art of how to make and/or use the invention. However in certain instances, well-known or conventional details are not described in order not to unnecessarily obscure the present invention in detail.

The present invention provides for CELL UPDATE_CONFIRM/RADIO BEARER RECONFIGURATION messages that were previously received when the UE was in CELL_DCH to be used again for switching back to CELL_DCH. Alternatively, according to 3GPP TS 25.331, RRC control signaling messages can be configured through pre-configuration.

The number of bytes used for control signaling can be reduced by using one of the pre-configuration and the previously received configuration. Depending on whether a pre-configured message or a previously received and stored message is used for the state transition, two options are listed below.

Option 1: Using Pre-Configuration for State Transition

The CELL UPDATE CONFIRM/RADIO BEARERRECONFIGURATION messages pre-configured for the purpose of switching between CELL_FACH and CELL_DCH are sent to the UE at the beginning of the connection establishment or at the first time the UE moves from CELL_FACH to CELL_DCH.

When a UE using the pre-configured messages is ordered by a network to switch between the CELL_FACH state and the CELL_DCH state, the network only needs to specify the new state the UE is to switch to, together with the index to the pre-defined configuration to be used in the new state. It acts just like a CELL_FACH← →CELL_DCH switch command.

In the physical layer Information Element (IE), the F-DPCH and E-RGCH/E-HICH codes can be changed based on a network reallocation. The previous F-DPCH and E-RGCH/E-HICH codes can be stored in the UE and in case these codes are not reallocated, they can be used again while entering CELL_DCH. However, when these codes are reassigned to other UEs, they have to be communicated to the other UEs for every transition to CELL_DCHA UE can be sent 16 F-DPCH and 16 E-HICH/E-RGCH codes in advance. Every time when the UE enters into CELL_DCH, it is allocated code within those 16 codes. Thus, a code index of 4 bits is needed to communicate the codes to be used in the CELL_DCH state of a UE. Therefore, with the pre-defined configuration and pre-communicated F-DPCH and E-HICH/E-RGCH codes (when moving to CELL_DCH), a UE can obtain all information needed to switch between CELL_FACH and CELL_DCH.

Option 2: Using Previously Received and Stored Configuration for State Transition

If a previously received and stored configuration is used, the 4-bit field of the pre-configuration index illustrated in Option 1 above is not needed. Thus, the 4-bit field can be used to communicate a random ID, which could be used as a sequence number for sending an RLC level acknowledgement. Alternatively, the content of the 4-bit field can be generated based on an integrity algorithm, thereby providing integrity protection to the state transition command. The rest of the 8-bit field can be used as set forth in Option 1 above.

Both Options 1 and 2 can be used on a same network, with the Slot Format (SF) field used for distinguishing the option being used. The use of both Options 1 and 2 in the same network should be known to the UE and the network by standardization or through explicit system information broadcast. If only one of the options is used, the SF field can have a different meaning as will be explained below. For both Options 1 and 2, with a UE specific H-RNTI, when the UE detects a CRC corresponding to its H-RNTI, an unused combination of CCS fields may indicate that there is no data carried on the HS-PDSCH and only a state transition command is being communicated to the UE on HS-SCCH. Under this scheme, many HS-SCCH fields become redundant and are reinterpreted to communicate the state switch command for the following reasons:

TFRC (6-bit) field is redundant because there is no data/control message carried on the HS-PDSCH;

HARQ process (3-bit) is redundant assuming that no ACK/NACK is sent by the UE in support of HARQ operation;

Modulation Scheme (1-bit) is redundant, because in the absence of the UE's CQI, the network cannot use higher modulation schemes. Hence the modulation scheme can be fixed to Quadrature Phase Shift Keying (QPSK) for UEs in Enhanced CELL_FACH and make this field redundant;

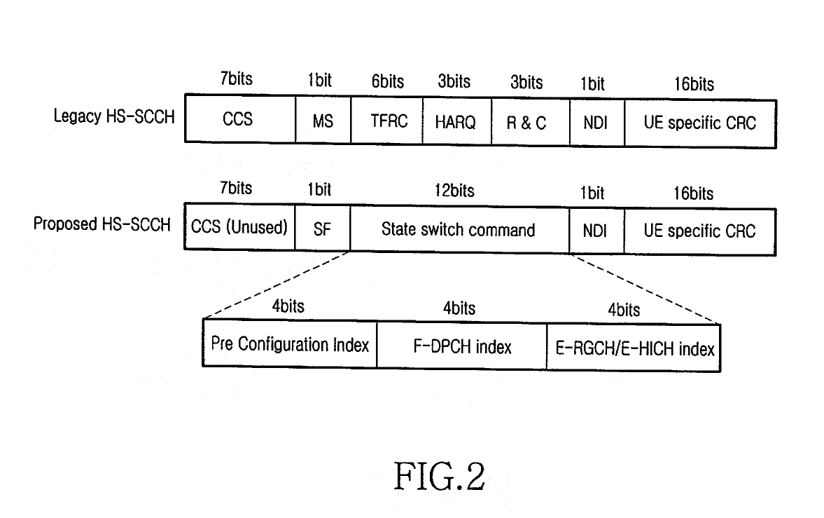

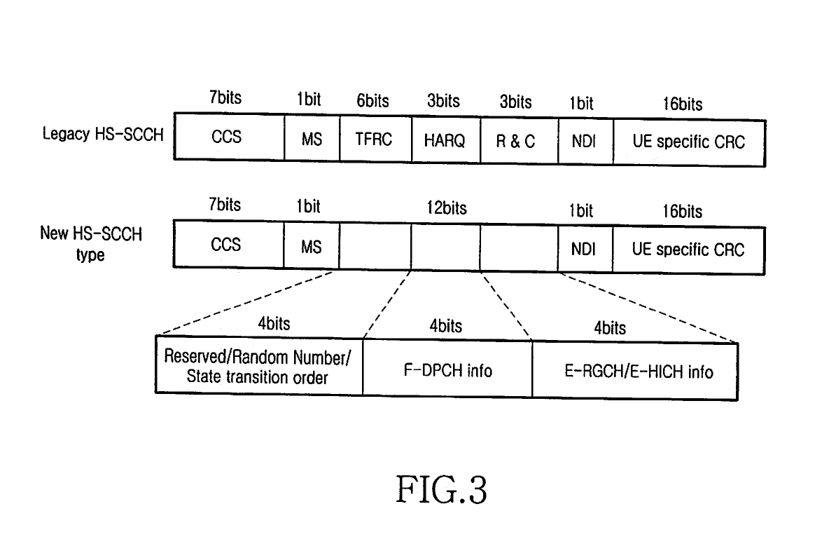

Redundancy and Constellation Version (R & C Ver) (3-bit) is redundant, because only “quick repeats” as specified in R1-062884 “Analysis of HSDPA in CELL_FACH State” are done, thus making this field redundant. Based on the fields that become redundant in HS-SCCH described above, a new HS-SCCH type for Enhanced CELL FACH for Option 1 is shown in FIG. 2; and a new HS-SCCH type for Enhanced CELL_FACH for Option 2 is shown in FIG. 3. When a UE is in Enhanced CELL_FACH state, the MS field is re-interpreted as HS-SCCH Slot Format field (SF), which indicates the usage of alternate HS-SCCH slot format. If SF equals 1, an alternate slot format is used and HS-SCCH contains a state transition command; If SF equals 0, the network can either use this option to solicit a Measurement/CQI report from the UE on RACH or to communicate a traffic volume measurement control message; If both Options 1 and 2 are used in the same network, the SF field may be used to indicate whether reconfiguration is being done through pre-configuration (Option 1) or through a previously stored RRC message (Option 2).

The F-DPCH index indicates which of the pre-configured codes are used for receiving F-DPCH. A set of 16 codes was pre-sent to the UE and this field indicates which of the 16 will be used for F-DPCH reception.

The E-RGCH/E-HICH index indicates which of the pre-configured codes are used for receiving relative grants and HARQ indications. A set of 16 codes is also pre-sent to the UE and this field indicates which of the 16 will be used for E-RGCH/E-HICH reception.

The 8 unused combinations in the CCS field can be used to indicate the state to which the UE is to switch to. The usage of this field is optional when UE only switches between CELL_FACH and CELL_DCH states.

The Pre Configuration Index field in r Option 1 or the Reserved/Random Number/State transition order field of Option 2 indicates the configuration to be used in the new state. Up to 16 configurations can be indicated using this field (Release 6 also uses 16 pre-configurations). Alternatively, the network may send a 4-bit random number if the previously received configuration is to be used for state transition.

When a UE in the Enhanced CELL_FACH identifies that the CCS field has an “unused combination” and SF equals 1, it decodes the state transition command, the F-DPCH index and the E-RGCH index according to the new HS-SCCH format and acts thereafter accordingly. There is no need for the UE to decode HS-PDSCH as no information is carried on it for the UE. The UE can identify the new command or retransmission by a New Data Indicator (NDI). For quick repetitions, the same HS-SCCH contents are repeated with NDI indicating whether it is a repeated command or a new transmission.

The reinterpretation of these HS-SCCH fields does not affect the existing HSDPA UEs because the UE specific CRC will not match the slot format for Release 5 UEs.

When only one of the two options is used, a combination of the CCS field having an “unused combination” and SF equaling 0 can be used by the network to solicit the Measurement/CQI report, which is responded to by the UE on RACH accordingly. This option enables the network to request the Measurement/CQI report, and support CQI based MCS selection with very small overhead. Alternatively, the network may communicate a reduced traffic volume measurement control message to the UE. The whole scheme is summarized in Table 2 below.

When a full control message or data plane packets are to be transmitted, a UE decodes the 16-bit UE specific CRC on each HS-SCCH to check if the CRC matches its H-RNTI. Channelization Code Set (CCS) indicates channelization codes where the data packets or the control message is carried for the UE. TFRC and logical channel ID assist the UE to decode the payload on HS-PDSCH(s) as in the current specification.

TABLE 2
Summary of HS-SCCH fields reinterpreted

| CCS | MS/ | |
|---|---|---|
| Field | SF field | Interpretation |
| Valid | MS = QPSK | UE reads HS-PDSCH as indicated |
| combination | or | by the CCS field and performs the regular |
| | 16 QAM | HS-FACH operation |
| Unused | SF = 1 | If Options 1 and 2 as described |
| combination | | above are not used in the same network, the |
| | | rest of HS-SCCH fields are reinterpreted as |
| | | per FIG. 2 if option 1 is used, or as per |
| | | FIG. 3 if option 2 is used |
| Unused | SF = 0 | If Options 1 2 are not used in the |
| combination | | same network, it can either use this option to |
| | | solicit the Measurement/CQI report or to |
| | | communicate a reduced Traffic volume |
| | | measurement control message |
| Unused | SF | If Options 1 and 2 are used in the |
| combination | | same network, this field indicates the option |
| | | being used on the fly. |

A pseudo code for distinguishing HS-SCCH is listed below:

```
    IF (CRC of HS-SCCH is OK):
      IF (UE is in Enhanced CELL_FACH and CCS field has unused
combination):
    => Re-interpret MS field as per Table 2 and rest of fields are
interpreted as per Figure 2 for option 1 and as per Figure 3 for option 2.
      ELSE IF (UE is in Enhanced CELL_FACH and CCS field
has valid combination):
          => receive HS-PDSCH as per CCS field and rest operation is
as existing
      ELSE
    => Discard HS-SCCH
    END
    END
```

The advantages for reducing the size of message communicating the state transition include: The current HS-SCCH 1/3 rate code rate can be used to provide good link reliability and fewer retransmissions. Current HS-SCCH is transmitted with high power to ensure reliable coverage over the entire cell. Using this method of present invention for communication of state transition command ensures good detection probability. Because link adaptation and MCS selection need not be communicated on HS-SCCH, the initial Measurement/CQI report on RACH is not needed to send a state transition command to UE. Better cell edge detection and performance are achieved with improved channel coding and reduced latency in communication due to fewer bits transmitted and fewer retransmissions.

Also, HS-PDSCH need not be used, leading to higher utilization of code space and increased cell throughput. Only 12 bits in HS-SCCH are encoded with 1/3 rate coding and are sufficient to communicate a state transition command. Node B power resources are more efficiently utilized. There is an option for the network to solicit Measurement/CQI report or to communicate Traffic volume measurement control message with very small overhead. There is reduced control signaling on the Iub interface between the RNC and the Node B.

When a previously received and stored configuration is used for state transition, an RLC level acknowledgement can be supported with integrity protection to achieve virtually 0% error probability.

It will also be obvious to those skilled in the art that other control methods and apparatuses can be derived from the method of the present invention as taught by the description and the accompanying drawings and these shall also be considered within the scope of the present invention. It should also be noted that the host for storing the applications includes but is not limited to a microchip, microprocessor, handheld communication device, computer, rendering device and multi-function device.

Although a preferred embodiment of the present invention has been described for illustrative purposes, it is noted that various changes and modifications are possible and are apparent to those skilled in the art. Such changes and modifications are to be understood as included within the scope of the present invention as defined by the claims without departing from the scope and spirit of the present invention.

What is claimed is:

1. A method for efficient state transition between a CELL_DCH state and CELL_FACH state in Enhanced CELL_FACH, the method comprising the steps of:
a) conveying through a high speed shared control channel (HS-SCCH) one of pre-configuration information and previously received and stored information for state transition; and
b) transitioning the state between the CELL_DCH state and the CELL_FACH state in accordance with the conveyed information.

2. The method as claimed in claim 1, wherein the pre-configuration information is sent using one of CELL UPDATE CONFIRM and RADIO BEARER RECONFIGURATION messages at the beginning of connection establishment

3. The method in claim 1, wherein the pre-configuration information is sent using one of CELL UPDATE CONFIRM and RADIO BEARER RECONFIGURATION messages at the first time when a user equipment (UE) moves from the CELL_FACH state to the CELL_DCH state.

4. The method as claimed in claim 2, further comprising ordering which state the UE has to switch to and an index to the pre-defined configuration to be used in the new state.

5. The method as claimed in claim 1, further comprising:
storing prior F-DPCH and E-RGCH/E-HICH codes in a UE; and
entering the CELL_DCH state using the stored prior F-DPCH and E-RGCH/E-HICH codes which are not reassigned.

6. The method as claimed in claim 1, further comprising:
storing prior F-DPCH and E-RGCH/E-HICH codes stored in a UE;
re-transmitting the F-DPCH and E-RGCH/E-HICH codes when the prior F-DPCH and E-RGCH/E-HICH codes are reassigned; and
entering the CELL_DCH state using the re-transmitted F-DPCH and E-RGCR/E-HICH codes

7. The method as claimed in claim 1, further comprising:
sending 16 F-DPCH and 16 E-HICH/E-RGCH codes to a UE; and
signaling an index of the codes when there is a change in the F-DPCH and E-HICH/E-RGCH codes.

8. The method as claimed in claim 1, further comprising:
detecting a corresponding Cyclic Redundancy Check (CRC) code of a UE, specified by H-RNTI; and
indicating that there is no data carried on HS-PDSCH and a state transition command is communicated in HS-SCCH.
